(19) United States
(12) Patent Application Publication
(10) Pub. No.: US 2003/0037072 A1
(43) Pub. Date: Feb. 20, 2003

(54) MANAGEMENT OF VIRTUAL TRADING-STAMP SERVICES IN PUBLIC NETWORKS

(76) Inventors: MARK TWEED BOWMAN, BOCA RATON, FL (US); JAMES M. DUNN, OCEAN RIDGE, FL (US); EDITH HELEN STERN, BOCA RATON, FL (US); BARRY EDWARD WILNER, BRIARCLIFF MANOR, NY (US); SUSAN YEE, CORAL SPRINGS, FL (US)

Correspondence Address: RICHARD A. TOMLIN, IBM CORPORATION, INTELLECTUAL PROPERTY LAW DEPARTMENT, 8501 CONGRESS AVENUE, IMAD-4042, BOCA RATON, FL, 33487, US

(21) Appl. No.: 08/977,541

(22) Filed: Nov. 25, 1997

(51) Int. Cl. G06F 12/00

(52) U.S. Cl. 707/201

(57) ABSTRACT

This concerns a method and system for using virtual trading stamps to conduct commerce on public data networks such as the Internet. Virtual trading stamp offers are distributed through the network to network users. These offers are presented on viewable pages of material and may have ancillary or no relevance to other information presented on the same pages. Offers may be presented in the form of icons having the appearance of trading stamps. Sponsors of such offers arrange for their distribution with hosts of what are termed cool sites on the networks (e.g. operators of popular or frequently “surfed” sites). A page transmitted from a cool site may contain plural offers from one or more sponsors. Each offer/icon is linked to a program applet designed to establish network contact with a stamp server when the respective icon is selected (“clicked on”) by a viewer. The stamp server may be part of a network of inter-communicating stamp servers operated by a common stamp management service enterprise. When an applet associated with a stamp offer is activated (e.g. by selection of a respective stamp icon) the viewer's site communicates with a stamp server, the viewer's site provides information enabling the stamp server to credit an appropriate client account, or to set up a new account and add stamp credits to it. Stamp servers also function to present clients with an initial page of viewable ad or other materials furnished by sponsors of accepted stamp offers. Stamp servers also may maintain a redemption catalog of items exchangeable for credits accumulated in client accounts. Stamp servers also may operate to collect statistical data with potentially important significance (since stamp management enterprises have potentially global exposure to masses of network users associating with numerous sponsoring enterprises and institutions. Stamp servers also function to link active clients (clients accepting stamp offers) with ad servers operated by sponsors. This enables sponsors to offer additional presentations of materials to such clients.

### CROSS-REFERENCES TO RELATED APPLICATIONS

Patent application Ser. No. 08/906,507 for DiAngelo et al, filed Aug. 8, 1997, titled Method of Internet Commerce Using Coupons, assigned to the assignee of the present application.

### BACKGROUND OF THE INVENTION

The commonly assigned related application above concerns maintenance of a rebate coupon system on public networks such as the Internet. In that system, advertisements offering sale of goods, services, or other items, are transmitted to network users along with coupon offers. Each coupon offers an instant discount or rebate on a product or service presented in the advertisement. The offer may be either real (e.g. printable at the user's site and taken or mailed to a business site for a discount on purchase of the advertised item) or virtual (e.g. directly applied as a discount from the purchase price of the advertised item, assuming that the purchase transaction is completed through the network. In either form, the coupon offer has a definite monetary value associated with the price of the advertised item.

However, we envision circumstances wherein the advertisement need not directly involve a product offering subject to such rebates. For instance, a typical practice in the development of commercial “mailing lists” (e.g. lists of potential consumers of particular products or services) is to distribute questionaires to potential consumers and use responses thereto to allocate respondent addresses to mailing lists. In such instances, sales of specific goods may be rather remote from objectives of either the distributor of the questionaire or its recipients.

Another example is an advertisement (hereafter, “ad”) highlighting or publicizing a corporate name (e.g. Ford, General Motors, etc) without reference to a specific product or service (e.g. an ad featuring a sporting event—golf tournaments, the Olympics, etc—and listing corporate sponsors but not their products).

Thus, rebate coupons of the type contemplated in the related application might not be effective to motivate network users to merely view a specific ad, respond to a specific set of questions, or perform other acts not necessarily directly involving sales transactions.

Our invention is directed to managing a system of virtual stamp credit offerings useful as inducements to have network users view specific ads or perform other activities that need not direct or immediate relevance to sales functions.

### SUMMARY OF THE INVENTION

Our invention concerns a system and method for using virtual trading stamp credits to conduct commerce on public networks such as the Internet.

Offers for virtual trading stamp credits are distributed through the network within pages of viewable materials that are presentable (downloadable) to network users. Offers may be in the form of viewer selectable icons or other indicia. Offering icons may have the graphic appearance of trading stamps.

The distribution of such offers is managed by sponsors of respective offers. Sponsors make arrangements with proprietors of “cool sites” on the network (e.g. sites considered popular or apt to be frequently “surfed”) for incorporating their offering icons (or other indicia) into viewable pages of materials distributed from the cool sites. Offering icons/indicia need not have any direct association to other matters of interest presented on respective “cool” pages. A single cool page may contain plural offering icons of one or more sponsors. A sponsor may also host one or more cool sites.

Offering icons/indicia are linked to a network site containing a stamp server. The stamp server, which may be part of a network of stamp servers operated by (hosted by) a stamp management commercial enterprise, inter-acts with network users when the latter act to select offering icons/indicia on pages distributed by cool sites. Such inter-actions result in addition of trading stamp credits to client accounts set up for these users, as well as presentations of additional matter to these users. The additional matter relate specifically to interests of sponsors of respective offers (e.g. they may be ads, questionaires, etc., relating to products, services or other things sold or considered interesting by sponsors).

Present stamp servers also act to maintain redemption processes for participating clients/users, and to gather statistical data. This last function of statistical data collection is considered particularly interesting, unique, and potentially important. A stamp management commercial enterprise operating such stamp servers has potential global involvement with vast numbers of network users reacting to a great variety of materials presented by many different sponsoring enterprises and institutions. Thus, statistics collected by the stamp management enterprise can have great commercial significance not only to sponsors but possibly to all commercial enterprises and governmental institutions.

Links between network users and stamp server(s) are preferably implemented by means of program applets. Such applets may be transmitted to network viewers with cool pages, and they may contain functional commands written in a programming language that is interpretable or executable by conventional network browsers; e.g. the presently popular and highly publicized Java¹ language. ¹Java is a trademark of Sun Microsystems Corporation

Linking applets may be constructed to perform many functions relative to network communications with stamp servers; for example, they could be designed to support automatic authentication processes for enabling stamp servers to verify client identities and passwords or other authorization indicia in a “user-friendly” manner when user activities activate potential updates of client accounts.

To summarize, presently contemplated stamp management enterprises are responsible for: a) transmitting a displayable page of ad (or other) materials relevant to matters of interest to a viewer who selects an offering icon/indicia on a cool page; 2) determining if the selecting viewer is currently enrolled as a client of the stamp server's enterprise (i.e. if the viewer has an existing stamp credit account); 3) adding a specific number of point credits to the client's account if one exists, or interacting with the viewer to create a new account and adding the specific credits to it; 4) managing redemption activities between clients and their accounts; and 5) collecting statistical data relative to client activities. The redemption management functions and statistical data collecting functions could be carried out by processing entities separate from stamp servers if such would be more efficient for the management enterprise.

If displayable matter sent from the stamp server to a client (selecting viewer) is the first of two or more pages of material issued by a respective sponsor, the transmission containing the first page may include a selectable link to an ad server site containing the additional pages to be presented. Ad servers are operated by sponsors.

Any award of stamp credits associated with a viewer selected icon/indicia on a cool page may be made on either an unconditional basis (i.e. added to the viewer's new or existing client account based only on the selection of the respective icon) or a conditional basis (i.e. added to the respective client account based upon further interaction between the viewer and stamp server relative to the first page of displayable matter sent by the latter in response to the selection). A single viewer selection also may invoke plural credit awards; e.g. an unconditional credit based upon the initial selection, and a conditional additional credit based upon an additional interaction between the user and stamp server.

Each stamp icon or other viewer selectable indicia, as presently contemplated, contains a clear indication of the number of credit points associated with its selection and a design or other matter that may be unique to the sponsor. The icon may contain graphics, either static or animated, with a “glitzy” appearance (i.e. designed to attract attention). Although such graphics may affect the success of the icon's usage (the number of times it is selected) they are not considered a part of the present invention.

The ad and stamp servers (or ad, stamp, redemption and data collection servers if four distinct entities are required) are data processing systems; preferably, general purpose computers (or multiprocessor systems) employing software including applications for implementing network functions associated with this invention. A less preferred implementation would be in the form of special purpose hardware dedicated to functions required presently.

Management of the redemption functions requires maintenance of a catalog of items (goods, services, etc.) redeemable for specified point amounts. Pages of the catalog should be transferable through the network. The client should be able to access the catalog either to simply view its contents, or to view its contents and execute a redemption against a respective client account. A redemption may be executed for all or part of the accumulated point credits in the account. Client access to the redemption/catalog viewing process may be based upon information furnished to the clients network browser when the account is established; e.g. an Internet URL associated specifically with such access, and representing either a port on the stamp server or a port on a separate redemption server.

When appropriate, the viewer selectable stamp icon or other indicia should indicate that all or part of the associated stamp credit award is conditioned upon viewing and registering reaction to additional ad or other matter to be sent to the viewer. Once selected, the selected icon or other indicia (and its links to the stamp server) should be allowed to die or time out cleanly at the client's site; i.e. without continuing to occupy RAM or other memory at the client's site.

A feature of the invention is concerned with maintaining proper coordination between operations of the ad server and stamp server so that ad materials contained in more than one page are presented to the client without undue delays between page presentations.

Another feature of the invention is its potential for collecting statistical data of potentially massive and unique scope.

These and other features, aspects, advantages and benefits of the invention will be more fully appreciated by considering the following description and claims.

### BRIEF DESCRIPTION OF THE DRAWINGS

FIG. 1 is a schematic of a network containing a virtual trading stamp system according to the present invention.

FIG. 2 is a chart for explaining how presently contemplated stamp offerings are created and presented to network users.

FIG. 3 is a flowchart for explaining interactions between a network user accepting a stamp credit offer and a stamp server managing user registration and stamp credits.

FIG. 4 is a flowchart for explaining interactions between a network user and an ad server in accordance with the present invention

FIG. 5 is a flowchart for explaining redemption processes pertaining to stamp credits accumulated in accounts managed by the above-mentioned stamp server.

FIG. 6 is a schematic illustration of the contents of a typical cool page.

FIG. 7 is an enlargement of one of a plurality of simplistically drawn stamp icons shown as rectangular outlines in FIG. 6.

FIG. 8 is a table of data collected by the stamp server, this table containing client information.

FIG. 9 is a table of data collected by the stamp server, this table containing client demographics information.

FIG. 10 is a table of data collected by the stamp server, this table containing information specific stamp offers and client activities related thereto.

FIG. 11 is a table of data collected by the stamp server, this table containing information about sponsor ad pages and client activities relevant thereto.

FIG. 12 is a table of data collected by the stamp server, this table containing information about client redemption activities.

FIG. 13 is a table of data collected by the stamp server, this table containing information about items purchased by redemption and client activities related to such items.

### DETAILED DESCRIPTION

1. Network Embodiment of Invention

FIG. 1 shows general aspects of a preferred embodiment of the invention. The public network here is the Internet. Server 1 is part of an Internet Service Provider (ISP) system that links user sites 2 to the network. For simplicity, only a single site 2 is shown, but it is understood that the ISP system and its (local) server 1 are able to serve potentially large masses of network users without geographic confinement to specific lands or national borders. Although a laptop computer is illustrated at 2 it is understood that any processing unit (personal or other type computer, or even a television set specifically adapted for network access) can be used for presently considered functions.

Stamp server 3, which constitutes a principal element of the present invention, may be operated by a stamp management enterprise offering the present services pertaining to virtual trading stamp credits. These services may include: inter-acting with network users to establish client accounts for users, inter-acting with clients to receive identification and other information from clients (including information required to add credits to the client accounts and information needed to associate individual awards with specific sponsors), adding virtual trading stamp credits to such accounts when clients/users perform predetermined actions, sending viewable advertising (ad) materials to clients, and maintaining a redemption process accessible to clients.

For these purposes, server 3 (or the stamp management enterprise hosting it) maintains a database 4 which includes at least the data suggested at 5; i.e. it includes at least: (a) data of client user accounts; (b) data furnished by stamp sponsors (business enterprises sponsoring specific virtual stamp offerings); (c) data for redemption of client account credits (a redemption catalog and information for supporting a redemption process relative to items in the catalog); and (d) statistical data derived from interactions between the stamp server and clients. The statistical data mentioned last could be quite unique and potentially important because of the global scope of present public networks, and the potentially large masses of people that could be reached as clients. Thus, this data could be useful to the stamp management enterprise, sponsors of stamp offers, and even business enterprises and governmental institutions having no direct affiliation with either sponsors or stamp management enterprises.

Each stamp server such as 3 communicates through the Internet with Sponsor offices; one of the latter indicated at 6. Each sponsor office contains or links to an ad server shown at 7.

Sponsor offices also communicate through the Internet with servers 8 maintained by proprietors of “cool” sites (network sites likely to be frequently accessed/“surfed” by network users). In accordance with the present invention, sponsors establish contractual relationships with proprietors/hosts of cool sites and distribute virtual stamp offers to network users through servers at the cool sites. Distribution involves placing viewer-selectable indicia (typically, a stamp icon) into displayable pages of material that are downloadable from cool sites to users. Such indicia manifest and represent virtual stamp credit offers. Accompanying such indicia are miniature software applications; e.g. applets written in Java language as mentioned earlier. These applets can be used to establish network links between viewers at user sites such as 2 and stamp servers such as 3. Typically, these applets would be initially activated when respective stamp icons or other offering indicia are selected by viewers (e.g. when the viewer presses a button on a pointing device such as a mouse while a cursor on the viewer's monitor screen is pointing at the indicia). Subsequent activations would occur when viewers perform predetermined actions after selecting a stamp icon (e.g. when viewers respond to sponsor questionaires sent by the stamp server and ad server after selection of a stamp icon).

In each interaction between a viewer selecting stamp indicia and a stamp server, the server adds virtual stamp credits to a client account set up for the viewer and maintained by the server. The stamp server also may send the viewer a page of displayable information furnished to the stamp server by the sponsor. That page typically would contain either an ad or some other solicitation of client interest (e.g. a questionaire). Material contained in that ad or solicitation typically would be related to commercial or other interests of the sponsor (e.g. the material could be directed to publicizing an event hosted by a governmental sponsor). The ad or other solicitation may be the first a series of pages intended for presentation, and in such instances the client's site is linked (e.g. by operation of the applet accompanying the selected indicia) to the ad server 7 of the distributing sponsor after transfer of the first page from the stamp server to the client.

Virtual stamp credits accumulated in a client account are subject to redemption by interaction between the client and either the stamp server directly or a redemption server with links to the stamp server. It should be understood that the number of stamp credits needed to acquire an item of minimal value from the catalog might be considerably greater than the numbre of credits that could be acquired in a single transaction between a client and stamp server; i.e. it should be understood that individual stamp awards may not have any real value (in contrast to coupons for discounts on immediate purchase transactions).

Dotted line 9 schematically symbolizes a line of demarcation between network elements involved in what are presently termed preparation processes and elements involved in what are termed activation and redemption processes. Preparation processes involve activities between sponsor offices and other processing entities relating to placement of stamp offers at “cool” sites (e.g. sites deemed likely to attract users of sponsor products or services and/or individuals likely to be interested in matters of interest to a sponsor) and distribution of viewable matter from cool sites to network users. Activation processes involve interactions between network users and the stamp server, and associated interactions between users and the ad server. Redemption processes involve interactions between network users and either the stamp server directly if it has redemption responsibilities or a (not-shown) separate redemption server if the redemption responsibility is placed at a separate server entity.

These processes are described in following sections 2-5.

2. Preparation

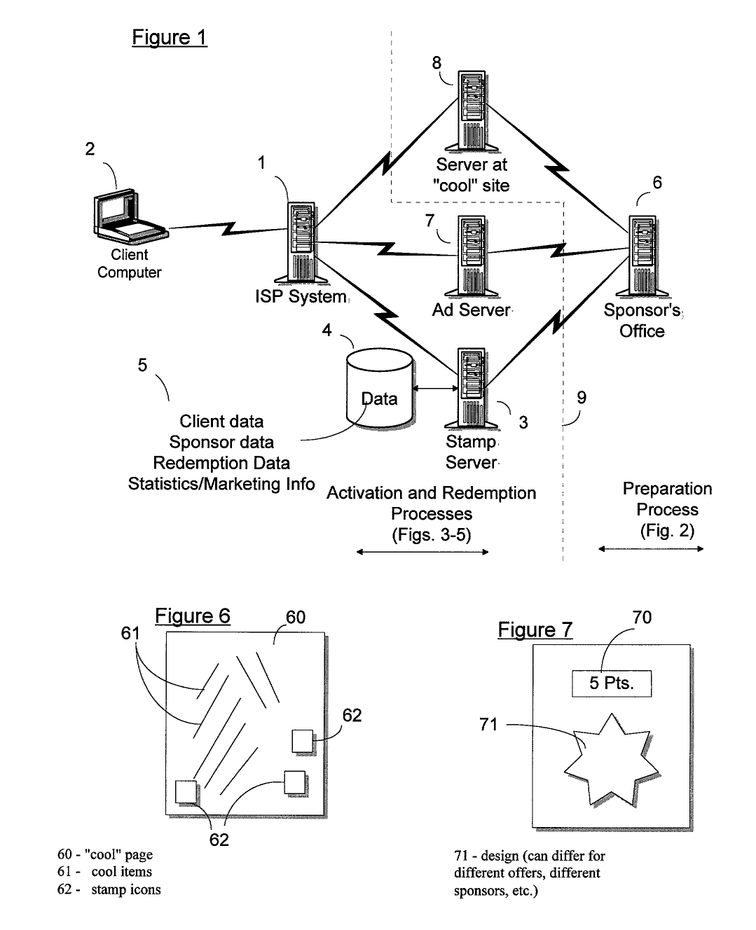

Preparation processes are explained with reference to the flowchart in FIG. 2.

As shown at 19, to prepare for circulation of a stamp credit offer through the network, the offer's sponsor contracts with hosts of cool sites to incorporate a stamp icon (or equivalent indicia) representing the offer into displayable network pages. These pages are accessible to network users employing standard browser applications. Each stamp offer may require contractual arrangements between a respective sponsor of the offer and multiple hosts; i.e. hosts of all cool sites that the sponsor feels may be browsed/accessed by network users likely to be interested in the offer.

The stamp icon (or equivalent indicia) is viewer selectable; i.e. it is a hyper-linked construct. This means that when the icon is selected (e.g. by operation of a button on a viewer's pointing device) the viewer's network browser application is linked to activation processes described in section 3 below. Such processes establish communication interaction between the viewer's site and the stamp server through the network.

A sponsor may host one or more cool sites, but in general would have to contract with hosts of many other such sites to achieve effective circulation of a stamp offer. A sponsor may have multiple different stamp credit offers in circulation at any time, such different offers being represented e.g. by stamp icons having different appearances and/or different posted valuses of awardable trading stamp credits.

A sponsor may be a business enterprise, a governmental institution (e.g. a school) or even a private individual seeking to publicize a matter of personal interest.

For each stamp credit offer placed at a cool site, the sponsor furnishes information to a server at the cool site (through the network). This information forms the display of the stamp icon representing the offer and creates a hyperlink association between that icon and a program applet discussed below. The program applet is activated when the icon is selected by a viewer. When activated, the applet causes the viewer's computer system to communicate with the stamp server as described later.

As indicated at 20, the sponsor prepares one or more pages of displayable advertising matter or other materials to be sent to network users selecting its stamp offer. This material is prepared either at the sponsor's office (6, FIG. 1) or at its ad server (7, FIG. 1), depending upon resources available at these sites and existing practices of the sponsor's enterprise. As indicated at 21, the sponsor sends data to the stamp server for identifying the offer associated with its stamp icon, enabling the stamp server to issue appropriate stamp credits to network users/clients selecting that icon. The sponsor also sends a page of ad or other materials for presentation to a client selecting the icon, and if appropriate authorizes the stamp server to issue additional trading stamp credits if a viewer performs actions indicating designated reactions to the materials. In the activation process described later, the additional material is sent by the stamp server to each client selecting the stamp icon. If the page of materials sent to the stamp server is the first of a series of pages to be presented to clients, the sponsor transfers the additional pages to its ad server and interacts with the stamp server to establish linkage between the client and ad server when the stamp server completes its interaction with that client.

As shown at 22, the stamp server furnishes the sponsor with the aforementioned linking applet to associate and distribute with the latter's stamp icon; i.e the applet for linking viewers selecting the stamp icon to the stamp server. The sponsor then distributes the linking applet to cooperating hosts of cool sites (see discussion of operations 19 above).

As indicated at 23, hosts at cooperating cool sites incorporate the icon and linking applet into pages of displayable matter circulated to network users from respective cool sites.

3. Activation

Processes for activating trading stamp awards are shown in FIG. 3. These processes, which are evoked when the user selects a trading stamp icon representing a stamp credit offer, involve interactions between the user and the stamp server responsible for managing client accounts.

As shown at 30 and 31, an activation process begins when a user with a “Java-enabled” network browser application (an application responsive to commands written in Java language) views a page downloaded to the user from a cool site, and selects an icon representing a stamp credit offer. Such selection activates the applet accompanying the information pertaining to the icon. As noted earlier such applets could be written in the Java programming language. Since that language is presently used extensively in networks such as the Internet, most existing network browsers are responsive to commands in that language (i.e. they are Java-enabled).

The activated applet routes a message to the stamp server identifying the selected icon and the network user who selected it. The stamp server compares the user identity to its records and determines if the user is or is not a known client of the server (decision 32).If the user is not known (does not have an existing client account), the stamp server executes operations 33-35 to create a new client account and proceeds to operations 36 when the new account is correctly established. If the user is known the stamp server jumps directly to operations 36 from decision 32.

In operation 33 the server interacts with the user to set up the new account, and then checks to see if all the information required has been properly entered (decision 34). If additional information is required the user is prompted (operation 35) and interacts further to supply the additional information (iteration of operation 33). When all required information has been properly entered, the stamp server advances to operations 36.

In operations 36, the stamp server adds award credits to the client's account corresponding to the amount of credits stipulated in the stamp icon. The server also sends the client/user the first page of ad (or other material of interest) supplied by the sponsor (refer to operations 21 in FIG. 2). If the first page of material contains hyper-linked elements indicative of client reactions to the material, selection of such elements by the client re-activates the above-mentioned applet to transmit messages to the stamp server identifying such selections. If additional information is required to assess the client's response to a selected element (“no” result at decision 37) the client is prompted (operation 38) for the additional information. When all required client reaction information has been registered at the stamp server, the stamp server performs operations 39.

In operations 39 the stamp server provides the linking applet at the client with the network address (URL) of the ad server. This concludes the interaction between the client and stamp server, but it may lead to ancillary interactions between the client and ad server, as suggested at 39, resulting in downloading of additional sponsor ad pages to the client's site. These operations are conditional on the client acting to extend the activation process; e.g. by clicking on hyperlinked text or graphics within the first page of ad matter sent by the stamp server. Obviously, the client may terminate the activation process at any time by either logging off the network or taking other action relative to the page currently viewed.

4. Activities Ancillary to Activation

Activities ancillary to activation include inter-actions between clients and the ad server. In such activities, additional pages of ad material are presented to the clients (pages additional to the first page presented by the stamp server as described in the preceding section).

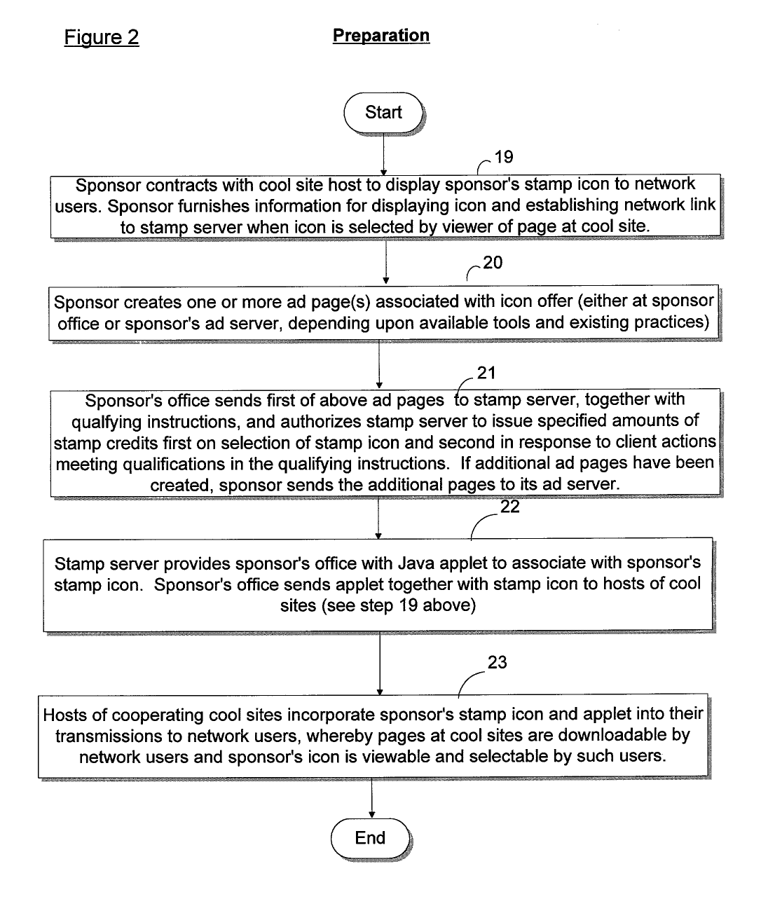

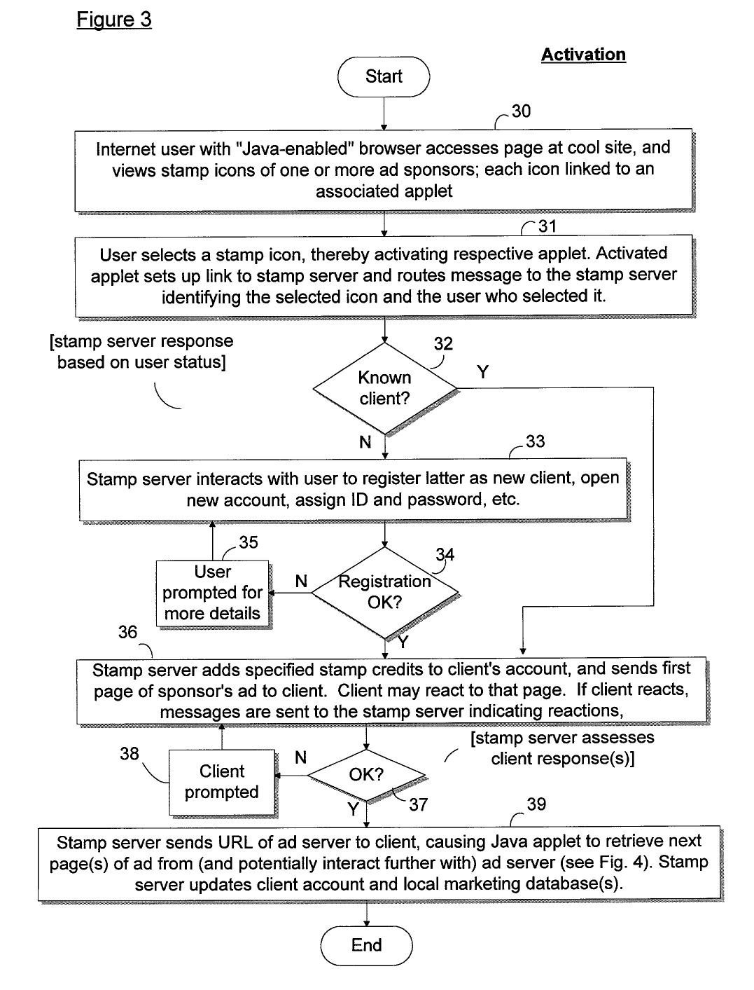

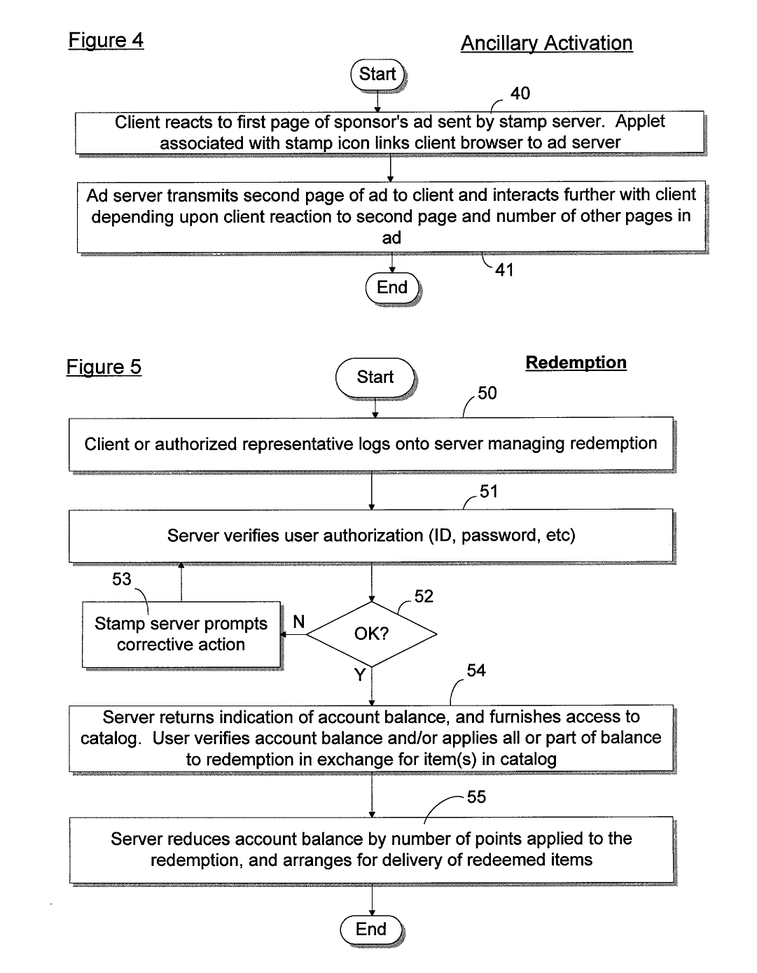

Such activities are explained using FIG. 4. As shown at 40 in this figure, if a client reacts to matter contained on the first page of sponsor material sent by the stamp server—e.g. by clicking on hyper-linked text or graphics contained on that page—the applet associated with the original stamp offer is re-activated to secure a link to the ad server (i.e. to obtain the latter's URL as explained earlier). This link enables the applet in cooperation with the client's network browser application to access the ad server site and download additional pages of sponsor ad matter or other materials (operations 41). The additional pages may contain hyper-linked text or other areas which if selected by the client would evoke additional interactions between the client and ad server. The additional inter-actions may be used to award additional virtual stamp credits to the client—e.g. via activations of additional links between the above applet and the stamp server—and for any other purposes deemed important by the sponsor and/or stamp management enterprise.

5. Redemption

FIG. 5 illustrates redemption activities in which the client directly contacts the stamp management enterprise (e.g. through a predefined URL for redemption). The contact may be with the stamp server directly or with a separate processing entity if that becomes necessary (e.g. due to excess client activation traffic at the stamp server). If a separate processing activity is needed that entity would have to exchange client data with the stamp server either through the public network or through a private or dedicated link.

As shown at 50 and 51, the client or pre-authorized representative of the client logs onto the server managing redemption—i.e. the stamp server or another server entity if needed—and interacts with the server to establish authorization to use the respective client account. If additional information is needed for this (decision 52) the user/client is prompted for such (operation 53).

After establishing authorization, the server returns an indication of the current account balance, and interacts further with the user/client (operations 54). Such further interaction may be used to provide the client with access to a redemption catalog database maintained by the server. If the client elects to proceed with a redemption purchase (i.e. an exchange of part or all of the accumulated stamp credits in the client's account for one or more items in the catalog), that is handled in the further interaction (operations 54). As indicated at 55, if a purchase is made, the server reduces the stamp point balance in the respective client account by the number of points needed for the purchase, and arranges for delivery of the purchased item(s).

6. Forms of Cool Pages and Stamp Icons

The format of a typical cool page is suggested schematically in FIG. 6 and the format of a typical stamp presented on such page is indicated schematically in FIG. 7. Aside from presentation of stamp offers, actual content of cool pages is irrelevant to the present invention. Also, as suggested earlier, esthetics, animation effects, and other aspects of stamp icon appearance are also irrelevant.

As seen in FIG. 6, a typical cool page 60 contains “cool matter” 61 (e.g. airline ticket prices or flight schedules) unrelated to stamp offers and one or more stamp offer icons 62. The offers 62 may have different associated sponsors.

A typical stamp format (FIG. 7) includes an area 70, indicating the number of virtual stamp credits applicable to selection of the respective icon, and one or more designs 71. The area 70 preferably should have uniform size, background and font characteristics for all stamp offers of a given type (e.g. for all “blue” stamps offered by a particular stamp management enterprise). The design(s) 71 could be different for different offers and/or for offers of different sponsors.

7. Data Collectable by the Stamp Management Enterprise

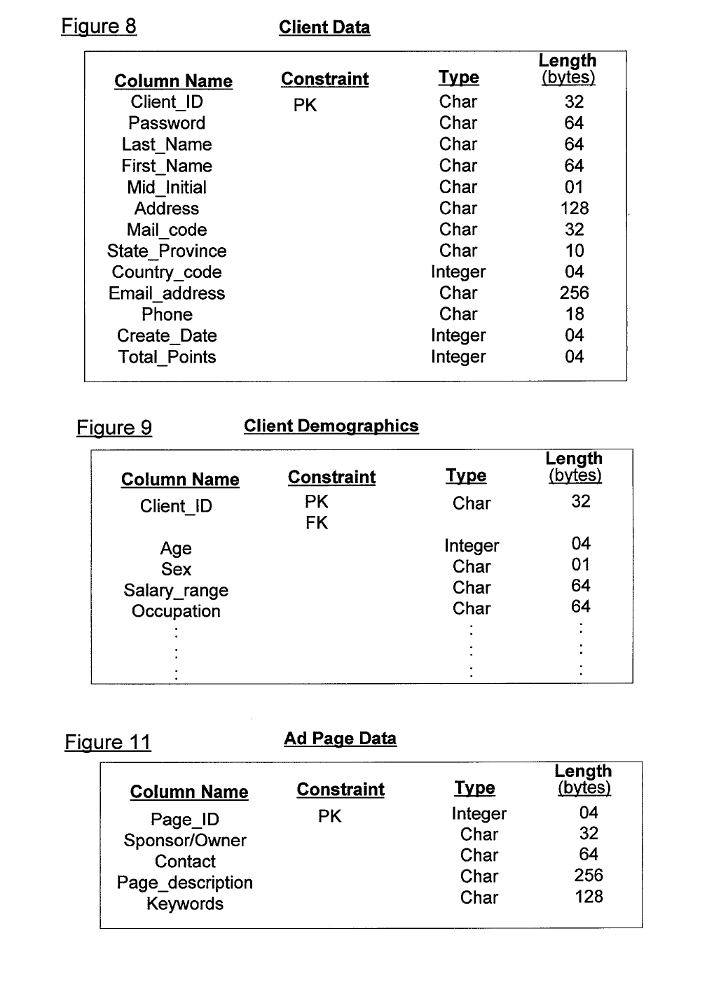

Tables in FIGS. 8-13 are used to illustrate the type of data which can be assembled by the presently contemplated stamp management enterprise and its servers. These tables indicate not only the variety of data available but also the pervasive global nature of that data and the masses of clients and sponsors to which it may relate. The result of considering these tables should be an appreciation of the potential significance of this data not only to the stamp enterprise and its stamp offer sponsors but also to businesses and governmental institutions which need not be involved either in stamp management or sponsorship of stamp offers.

Tables in FIGS. 8 and 9 contain information about clients. The table in FIG. 8 includes data unique to individual clients; i.e. client name, account identity, password, mail addresses (postal and Email; the postal address including a zip/mail code), telephone number, date account was created, points currently accumulated in account, etc. The table in FIG. 9 contains demographic characteristics—data for associating individual clients to groups of clients having common characteristics—such as age, sex, salary range (or income level), occupation, etc.

The table in FIG. 10 contains information about individual activation sessions relative to client/stamp accounts. This includes information such as the account identity string, the time at which the activity started and its elapsed time, the stamp type evoking the session, the ad page sent from the stamp server to the client in the session, the number of stamp credit points actually awarded in the session, the total number of available points that could have been awarded in that session, etc.

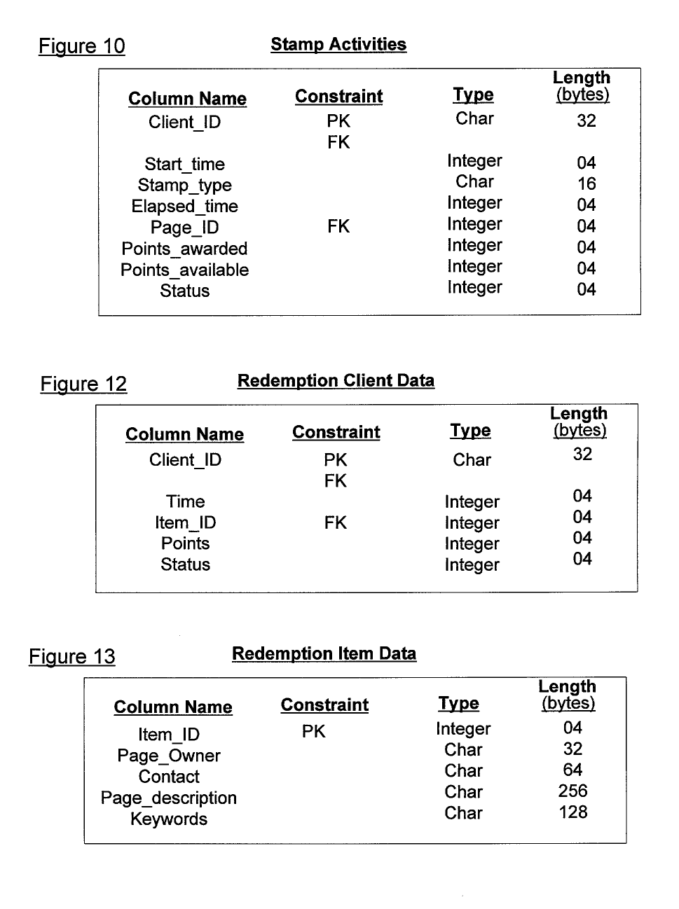

The table in FIG. 11 contains data about the ad page presented to the client, including the page identity, the identity of its owner/sponsor, contact information (designating how to contact the sponsor), a page description (in text), keywords for extracting statistical information from such descriptions in searches, etc.

Tables in FIGS. 12 and 13 contain information about redemptions. The table in FIG. 12 contains information about redemption activities by clients, including the client identity, the date and time of redemption, the identity of the item purchased (if two or more items are purchased in one redemption system, there will be two or more corresponding table entries), the account points applied to the purchase, and a status field (a field actually reserved for future use), etc. The table in FIG. 13 contains data about purchased items per se; such as the item identity, the owner of the catalog page describing the item (i.e. the source manufacturer or distributor that actually owns and ships the item), a contact point for that owner, a description of the catalog page for the item, keywords for extracting statistical data from the description, etc.

Row entries in these tables have the following meanings. Entries are bytes representing either numeric integers or alphanumeric characters as specified respectively by indications “Integer” and “Char” in the “Type” column. The number of bytes allowed for each entry is indicated in the “Length” column. Constraints for entries are indicated in the “Constraint” column. Constraints are represented by “PK” and “FK”. Constraint PK means that the respective row entry in that table is unique to or has a primary appearance in that table. Constraint FK means that the respective row entry has a secondary appearance in the respective table and a primary appearance in another table. Although not shown here (in order to simplify the drawing), it is noted that constraint indications FK should include associated indications of the identity of the table in which the respective row entry makes its primary appearance. Row entries having no constraint indication may be assumed to appear only in the respective table.

Entries common to plural tables include: “Client_ID”, “Sponsor/Owner”, and “Item_ID”. Client_ID's are alphanumeric character strings assigned to individual clients when their respective client accounts are established. They should be unique within a stamp management enterprise; i.e. a specific Client_ID string should be assigned to one and only one client of the enterprise. Sponsor/Owner indications are character strings uniquely identifying sponsors of individual stamp offers. Item_ID indications are integer strings used to uniquely identify items purchased by redemption.

1. A method of using virtual trading stamp credits to conduct commerce on a public data network such as the Internet comprising:
presenting viewer selectable indicia to users of said network within displayable pages of material transferrable to said users through said network; each said selectable indicia representing a stamp offer (e.g. an offer to the viewer of a predefined number of virtual trading stamp credits for selecting respective indicia), and being associated with interests of an enterprise constituting the sponsor of the stamp offer; such indicia being presentable in behalf of many different sponsors;
associating individual said indicia with miniature applications (applets) transferred to respective said users along with information forming said displayable pages; said applets being useful to establish network links for transferring data between said users and stamp server sites on said network;
in response to each selection of a said stamp offer indicia, by a said network user viewing a page containing respective indicia, linking the respective user to a stamp server operated in said network by a stamp management enterprise;
transferring data bidirectionally between said linked user and stamp server; and
adding virtual trading stamp credits at said stamp server to a client account maintained by said stamp server for said linked user.

2. The method of claim 1 wherein said indicia are icons having the appearance of trading stamps, and including:
associating with each icon a number representing the number of trading stamp credits awarded when the icon is selected; and
providing designs on said icons for visually differentiating offers of different said sponsors.

3. The method of claim 1 wherein said data transferred bidirectionally includes:
data sent from linked user to said stamp server for identifying said linked user;
data for identifying the network site currently being used by said linked user; and
data for uniquely identifying the stamp offers represented by said selectable indicia; said offer-identifying data effectively associating each offer uniquely with its sponsor and the amount of trading stamp credits to be awarded when the offer is accepted; and
data sent from the stamp server to said linked user for displaying a page of sponsor-related information to said linked user.

3. The method of claim 2 including, at said stamp server:
determining if said linked user has an existing client account maintained by said stamp server;
if said linked user has a said existing client account, adding a specific number of trading stamp credits to said existing acccount;
if said linked user does not have an existing client account, setting up a new client account for said linked user; and
adding said specific number of trading stamp credits to said new client account.

4. The method of claim 2 wherein said sponsor-related information displayed to said linked user constitutes an advertisement (ad) supported by the sponsor of the respective stamp offer.

5. The method of claim 2 wherein said sponsor-related information constitutes a solicitation of user interest (e.g. a questionaire) in any matter relevant to the sponsor of the respective stamp offer.

6. The method of claim 1 including:
operating a stamp redemption service under the direction of said stamp management enterprise.

7. The method of claim 6 wherein said stamp redemption service is directly executed by said stamp server.

8. The method of claim 1 including:
gathering statistical data within said stamp management enterprise based on operations conducted by network users relative to said client accounts.

9. The method of claim 8 wherein said statistical data is inherently global and diverse in character due to the number of clients and different sponsors potentially served by said stamp management enterprise.

10. A stamp management system for managing issuance and redemption of virtual trading stamp credits within a public network such as the Internet, said stamp management system comprising:
first elements, responsive to messages sent to said system from users of said network for identifying respective users; said messages being sent in response to acceptance by said users of offers of virtual trading stamp credit offers presented to said users at the direction of sponsors of respective offers;
second elements responsive to said messages for identifying a specific trading stamp offer accepted by each said user and indirectly identifying the sponsor of the respective offer;
third elements responsive to said messages for sending a displayable page of information to each said user, each said displayable page of information being pertinent to matters of interest to the sponsor of the stamp offer accepted by the respective user; and
fourth elements responsive to said messages for awarding a specific number of virtual trading stamp credits to client accounts maintained by said stamp management system for users identified by said first elements.

11. A stamp management system in accordance with claim 1 wherein said elements are contained within a common processor constituting a stamp server.

12. A system in accordance with claim 10 including:
fifth elements for conducting redemption activities enabling users having said client accounts to redeem their accumulated virtual stamp credits for items of value.

13. A system in accordance with claim 12 wherein said redemption activities include maintaining a catalog of said redeemable items of value.

14. A system in accordance with claim 12 wherein said items of value include merchandise, services, and other items such as airline mileage credits.

15. A system in accordance with claim 12 including:
sixth elements cooperative with said first through fifth elements to collect statistical data pertaining to activities conducted relative to said client accounts.
